(19) United States
(12) Patent Application Publication
(10) Pub. No.: US 2021/0298337 A1
(43) Pub. Date: Sep. 30, 2021

(54) Method of making a food kit for the preparation of fresh filled pasta, food kit obtained thereby and method of use

(71) Applicant: Bertagni 1882 S.p.A., Avio (TN) (IT)

(72) Inventor: Enrico Bolla, (US)

(21) Appl. No.: 17/250,398

(22) PCT Filed: Jul. 23, 2019
(86) PCT No.: PCT/IB2019/056260

§ 371 Date: Jan. 17, 2021

(30) Foreign Application Priority Data
Jul. 23, 2018 (IT) 102018000007432

(51) Int. Cl. A23L 7/109; A23L 3/36; A23L 3/015; A23P 20/20; B65B 25/00; B65B 31/02; B65D 25/04

(52) U.S. Cl. CPC A23L 7/111; A23L 7/11; A23L 3/364; A23L 3/0155; A23V 2002/00; B65B 25/001; B65B 31/02; B65D 25/04; A23P 20/20

(57) ABSTRACT

A method of making a food kit for on-demand preparation of fresh filled pasta having much the same properties as homemade fresh pasta includes making first components consisting of unit portions of single or double sheets of fresh pasta with a predetermined flat shape; cooling, vacuum packaging, high-pressure pasteurizing and refrigerating the pasteurized unit portion so as to maintain their structure and physical-rheological properties unaltered, and avoid pre-gelatinization of starches; and making second components consisting of pre-dosed pralines of filling, which later undergo pasteurization, packaging and possibly freezing. The first and second components are packaged and collected in a container for fresh or frozen storage, and are ready to be joined together in their present state or after thawing, for on-demand preparation of fresh filled pasta before cooking, thereby avoiding exchange of water, salts and other ingredients between the components.

### FIELD OF THE INVENTION

The present invention generally finds application in the field of food products and particularly relates to a method of making a food kit intended for on-demand preparation of fresh filled pasta, such as tortelli, ravioli, panzerotti and the like.

The invention further relates to a food kit obtained with the above method and its method of use by a final user.

### BACKGROUND ART

Filled pasta, comprising an envelope of pasta enclosing at least one filling therein has been long known among food products.

These food products are typical products of Italian gastronomy and the filling may be made of several types of ingredients such as, for instance, meat, fish, cereals, vegetables, cheese or the like.

Depending on the Italian or foreign regional tradition, these types of filled pasta are known as ravioli and tortellini, cappelletti or panzerotti.

Generally, the filling is placed in a sheet of pasta that is later closed on itself or between a pair of sheets that are intended to cover and enclose the filling.

This kind of food products may be found in the retail channel, i.e. in refrigerated cabinets of supermarkets and grocery stores, in bulk or prepackaged form and ready for cooking, so that users may save the time required for preparation of filled pasta for immediate consumption at a relatively low price, or in the HoReCa channel, i.e. collective food service, such as restaurants, canteens, catering.

Fresh pasta is available in a variety of types, depending on the production method, i.e. daily fresh, with no thermal treatment and up to 48 hour-shelf life, 10 days fresh, also handmade and with steam pasteurization, industrial fresh produced with automatic forming machines and with pasteurization and controlled-atmosphere packaging with over 60 day-shelf life at a temperature of 0-4° C. and frozen fresh pasta, made in large industrial facilities with pasteurization and freezing and very long storage time, up to 12-15 months at a temperature of −18° C.

Nevertheless, this type of pre-packaged filled food products suffers from the drawback that their organoleptic qualities and taste are quite different from those of hand-made fresh ones.

This is due to pasteurization of the sheets of pasta by heating in an aqueous or non-aqueous environment, or non-aqueous, which causes a change in the structure of the sheet caused by pre-gelatinization of starches.

This type of treatment is usually carried out in a steam-saturated chamber at a temperature that ranges from 80° C. to 100° C., or in water heated to 95-100° C., and the combined effect of time and temperature inevitably cause gelatinization of starches. This process, amongst other things, is also required for perfect sealing of the tortelli and prevent any spread of the filling from the tortelli during cooking; the correct moisture content of pasta (about 30% R.H.)

is required for gelatinization of starches with the combined effect of pasta exposure to a given temperature (80-100° C.) for a given time (2-10 minutes).

As a result of temperature and proper moisture, the mutually contacting pasta sheets (or one sheet folded on itself) release starch and cause the proper sheet adhesion.

Furthermore, during the period between forming of the filled food product and cooking by the user, the mutually contacting sheets of pasta and filling tend to exchange their respective organoleptic components in a natural diffusion process, which results in a quality loss in the final product.

This process of diffusion/exchange is inevitable, due to the nature of the components of the filled food product, which comprise water and fats that facilitate this process. Pasta has about 30% moisture content, 94% to 97% ambient relative humidity and 9-10% fats, and these values are compatible with diffusion processes (water) and prevents the creation of a barrier to avoid them (too low fat content).

In addition, the filling has 40% to 70% moisture content, 94% to 97% ambient relative humidity and and a fat content that cannot act as a barrier, which facilitates fast diffusion processes. This is because a higher water content in the filling results in faster diffusion.

Furthermore, the presence of salt (used in significant amounts in the filling) and other components (such as sugars), with the proper humidity, will further accelerate diffusion and exchange processes until the two components, i.e. pasta and filling, reach a balance. Water and salt cause substantial chemical modification of the two components until both reach a very similar Aw (water activity) value, which may be close to the relative humidity value.

The physico-chemical changes in the two components will cause a quality degradation; the higher the moisture content of the filling (i.e. the greater the amount of fresh raw material) the higher the changes and hence organoleptic degradation.

In an attempt to at least partially obviate these drawbacks kits for preparing filled or seasoned food products have been developed in which the food components are in a dry or dehydrated state.

US2002064585 discloses a food product comprising a sealed container for a first dry food component of predetermined shape and a second dry powder food component which is designed to be reconstituted with the application of a liquid to form the filling for the first food component.

One drawback of this prior art arrangement is that the first food component cannot be modeled to assume shapes desired by the user. Furthermore, the predetermined shape of the first food component prevents the user from sealing it with the filling therein.

A further drawback of this arrangement is that the second food component, even after humidification does not exhibit the same organoleptic properties and the same quality as a handmade filling.

One more drawback of this arrangement is that the first and second food components are both treated by the common pasteurization techniques as described above and the starches of first component are pre-gelatinized.

### TECHNICAL PROBLEM

In view of the prior art, the technical problem addressed by the present invention is to avoid pre-gelatinization of the sheets of pasta and the exchange of ingredients between the food components to thereby afford preparation of fresh filled pasta immediately before cooking, in much the same manner as the homemade one.

### DISCLOSURE OF THE INVENTION

The object of the present invention is to obviate the above drawbacks, by providing a method of making a food kit for on-demand preparation of fresh filled pasta, that is highly efficient and relatively cost-effective.

A particular object of the present invention is to provide a method and a kit of as described hereinbefore that might allow a user to manually prepare fresh filled pasta with much the same organoleptic qualities and taste as homemade fresh filled pasta.

A further particular object of the present invention is to provide a method and a kit as described hereinbefore that can prevent pre-gelatinization and fermentation of the sheets of pasta while avoiding the exchange of water, salts and other ingredients between the food components.

Another object of the present invention is to provide a method and a kit of as described hereinbefore that can facilitate coupling of each individual praline of filling in a corresponding sheet of pasta while avoiding the use of mechanical coupling means and/or starches and/or water.

A further object of the present invention is to provide a method of use of the food kit as described above that can allow a user to instantly manually prepare the fresh filled pasta, in a manner similar to the original, homemade processes.

Yet another object of the present invention is to provide a method of making, a kit and a method of use as described above that allow the user to prepare fresh filled pasta in a wide variety of shapes and types of products.

These and other objects, as more clearly explained hereinafter, are fulfilled by a method of making a food kit intended for on-demand preparation of fresh filled pasta, such as tortelli, ravioli, panzerotti and the like whose properties are similar to those of homemade fresh pasta, the method comprising making first components consisting of unit portions of single or double sheets of fresh pasta having a predetermined flat shape, cooling, vacuum packaging, high-pressure pasteurization and refrigeration of the pasteurized unit portions, to maintain their structure and physical-rheological characteristics unaltered, and avoid pre-gelatinization of starches, and making second components consisting of pre-dosed and conveniently shaped pralines of filling, which later undergo pasteurization and possibly freezing.

The first components and the second components are packaged and collected in a container for fresh or frozen storage, and are ready to be joined as they are or after thawing, for on-demand preparation of fresh filled pasta before cooking, thereby avoiding exchange of water, salts and other ingredients between the components.

One of the advantages of this process is that it avoids the need to modify the structure of the pasta due to the absence of high temperature water. Furthermore, the reduction of the microbial count is obtained without changing the chemico-physical structure of the pasta. The vacuum packaging minimizes any changes due to diffusion processes inside the pasta as well as degenerative processes caused by oxidation.

This process somewhat “hibernates” the pasta, which will maintain its initial characteristics until the package is opened. Then, the pasta may be used as if it were just been made.

With this process the sheet of pasta may be used exactly as if it were just been prepared and cut: once the filling is placed in its proper position of the unit portion of the sheet, the latter may be folded on itself with the filling therein, moistened to facilitate the sealing process, slightly pressed without using mechanical means, and then cooked. The sealing process will be completed during cooking.

The final product will exhibit a “silky” surface, an appropriate firmness and an excellent egg flavor, which are typical properties of fresh homemade pasta.

With the use of cold High Pressure Pasteurization (HPP), the unit portions of pasta will remain perfectly flat and smooth, which will facilitate perfect vacuum packaging, with a high-quality “aesthetic” effect, and a packaging having a good visual impact.

While high-pressure pasteurization has very high energy costs, it only affects 35-45% of the final product and in any case increases its added value and provides all the advantages of homemade pasta.

On the other hand, the filling will undergo a traditional pasteurization process, and possibly freezing, which will prevent initiation of fermentation and the increase of the bacterial count.

In a further aspect, the invention relates to a food kit for on-demand preparation of fresh filled pasta, obtained with the aforementioned method, as defined in claim 11.

In yet another aspect, the invention relates to a method of use of the food kit for on-demand preparation of fresh filled pasta as defined in claim 13.

Advantageous embodiments of the invention are defined in accordance with the dependent claims.

### BRIEF DESCRIPTION OF THE DRAWINGS

Further features and advantages of the invention will be more apparent upon reading the detailed description of a preferred, non-exclusive embodiment of a method of making a food kit intended for on-demand preparation of fresh filled pasta, a food kit as defined above and a method of use of the food kit, which are described as a non-limiting example with the help of the annexed drawings, in which:

FIG. 1 is a block diagram of the method of making a food kit of the invention;

FIG. 2 schematically shows the food kit obtained with the method of FIG. 1;

FIGS. 3 and 4 schematically show the method of use of the food kit of FIG. 2, and an example of fresh filled pasta that can be obtained with the food kit.

### DETAILED DESCRIPTION OF A PREFERRED EXEMPLARY EMBODIMENT

The accompanying figures show a method of making a food kit, generally designated by numeral 1, for on-demand preparation of fresh filled pasta P, mainly intended for preparation of dishes of high gastronomic quality.

Fresh filled pasta P is known to be a composite food product essentially composed of a pasta enclosure, with a filling 3 therein, composed of edible raw materials, as schematically shown in FIG. 4.

In particular, the fresh filled pasta P made with the method of the invention may be in the form of tortelli, ravioli, cappelletti, panzerotti or the like, and may be configured to be cooked immediately after preparation.

As is known, cooking may be namely carried out by a user either by boiling, e.g. in water or broth or by baking, microwaving or frying.

The method of the invention essentially comprises the production of first components 4 consisting of unit portions of single or double sheets of fresh pasta 5 having a predetermined flat shape and the production of second components 6 consisting of pre-dosed pralines of filling 7, which are conveniently shaped, pasteurized and possibly frozen.

The pre-formed unit portions of fresh pasta 5 may be obtained by pre-cutting a unit sheet into multiple portions, the unit portions 5 being obtained by final separation along pre-cut lines, not shown.

Preferably, the pre-formed unit portions 5 or multiple pre-cut portions are traditionally obtained with a first step of a) making a dough from common wheat and/or durum wheat flour, semolina, water and/or eggs.

The next step is a step of b) unidirectional and/or multidirectional lamination of the dough to obtain a continuous sheet of predetermined thickness s, preferably ranging from 0.3 mm to 1.5 mm, with known techniques as typically used for bakery products such as bread, croissants and the like.

The continuous sheet undergoes a step of c) cutting or pre-cutting into substantially flat unit portions 5 or multiple 5 whose shape and size correspond to those of a single piece of tortelli, ravioli, panzerotti or the like.

For this purpose, the unit portions 5 may have predetermined sizes and shapes according to the particular type of fresh filled pasta P to be prepared by the user and may be selected from the group including squares, triangles, diamonds and circles or any other geometric shape adapted to form fresh filled pasta P.

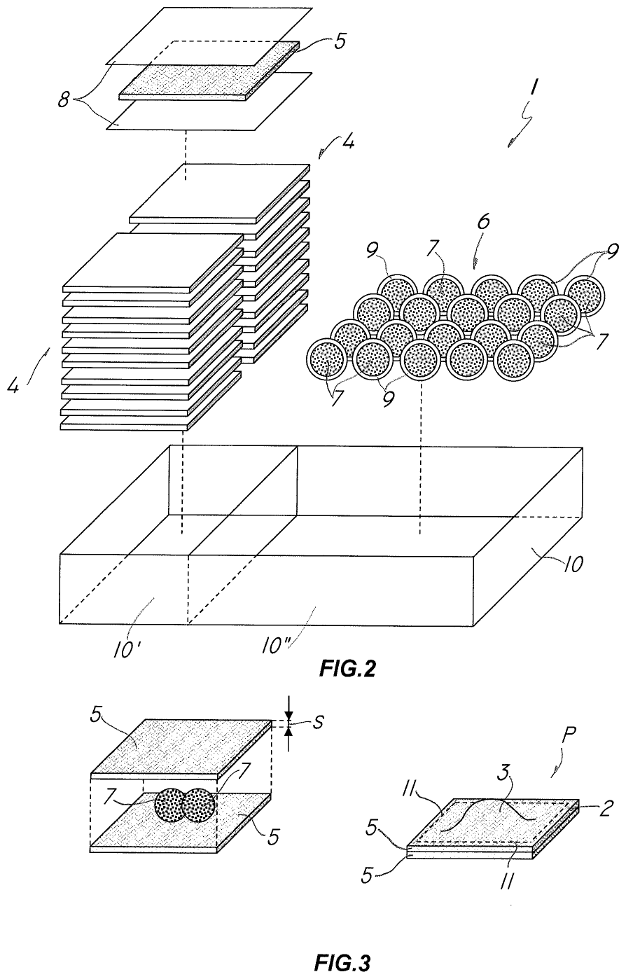

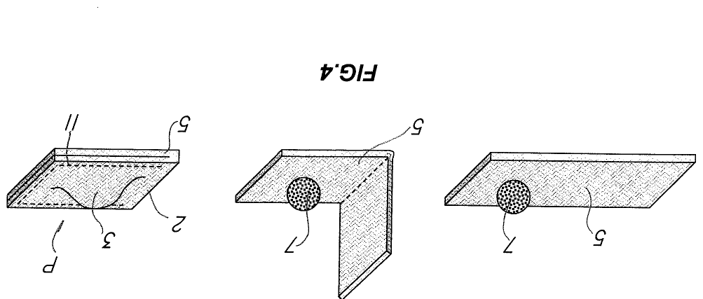

For convenience, the unit portions of FIGS. 2 and 3 are shown with a simple rectangular plan shape.

The cutting step c) is followed by a step of d) rapidly cooling the unit portions of fresh pasta 5 to a first temperature T₁ adapted to prevent any fermentation of the pasta.

Pasta fermentation is known to be caused by the natural action of yeasts and, in particular, lactic bacteria in the pasta and such fermentation changes the characteristics of the dough and hinders the user in forming of fresh filled pasta P.

It was experimentally found that rapid fermentation of pasta may be prevented if the first temperature T₁ of the cooling step d) is less than 8-10° C.

Suitably, the cut or pre-cut and cooled unit portions of the sheet of fresh pasta 5 are e) packaged under vacuum and in a controlled atmosphere by wrapping them in layers of biocompatible material 8. This packaging step e) may be carried out at a second temperature T₂ which is less than or equal to the first temperature T₁.

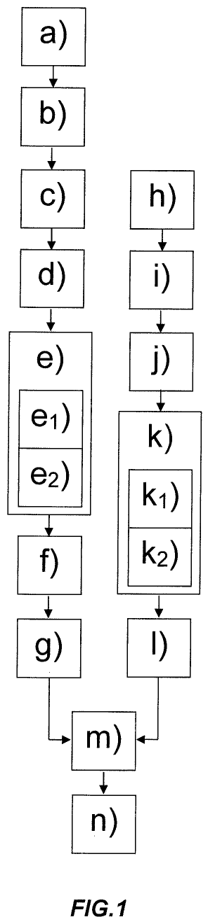

Conveniently, as shown in FIGS. 1 and 2, the vacuum packaging step e) may include a step of e₁) providing a number of layers of biocompatible material 8 and a step of e₂) placing a preformed unit portion 5 or multiple pre-cut portions, in each of the layers of biocompatible material 8.

These layers 8 may be preferably made of a food-grade biocompatible material and may be later sealed to maintain an appropriate degree of vacuum.

The vacuum-packaged unit or multiple portions 5 later undergo a step of f) cold High Pressure Pasteurization (HPP) at a third temperature T₃ which is adapted to avoid pre-gelatinization of the starch contained therein, such that the flat shape of the unit portions 5 will not be altered and the rheological and organoleptic characteristics of the base dough will be unaffected.

Conveniently, the second temperature T₂ of the vacuum packaging step e) may range from −5° C. to 10° C. and the third temperature T₃ of the pasteurization step f) may be less than 25° C.

High-pressure pasteurization (HPP) is carried out at a pressure PH ranging from 5000 bar to 6000 bar, for a time t ranging from 2 min to 6 min.

After the pasteurization step f), the unit portions 5 undergo a step of g) cooling and final storage at a fourth temperature T₄ to obtain first components 4 of the food kit 1 in a fresh or frozen state, such that their structure and physical-rheological characteristics are kept unaltered, by avoiding pre-gelatinization of starches.

Furthermore, the cooling and storage step g) may be carried out by freezing or storing the first components 4 at a fourth temperature T₄ ranging from 0° C. to 4° C.

According to the invention, the pralines of filling 7, are obtained by the steps of h) preparing a filling from appropriate ingredients according to a predetermined recipe, i) dosing the filling into individual pralines 7 whose weight and shape correspond to those of each piece of ravioli, tortelli, panzerotti or the like, j) pasteurizing the individual pralines 7 at ambient pressure, k) packaging the individual pralines 7 under protective atmosphere 7 in separate packages 9, l) cooling and refrigerating the individual pralines 7 to a fifth temperature T₅ to provide the second components 6 of the food kit 1 in a fresh or frozen state.

The ingredients used in the step of h) preparing the filling may be selected from the group comprising, for example, meat, fish, eggs, cheese, cold cuts, vegetables, cereals, protein- and fat-based substances, and other types of seasonings, flavors and sauces, even though these cannot be easily combined according to traditional recipes.

In a preferred embodiment of the invention, the steps h) of preparing and the steps i) of dosing the filling may comprise the method as disclosed in EP2900083, granted to the Applicant hereof.

In particular, the filling can be dosed by coextrusion using a dual-tube nozzle or, alternatively, single nozzles arranged in overlapping and concentric positions to obtain a pre-dosed praline 7 having two different fillings.

Conveniently, as shown in FIGS. 1 and 2, the packaging step k) may include a step of k₁) providing a number of separate packages 9 and a step of k₂) introducing an individual praline 7 with single or multiple fillings into each of the packages 9.

The packages 9 may be also formed with a food-grade biocompatible material and may a shape adapted to contain the praline 7.

According to the invention, the food kit 1 is formed by a step of m) introducing the first components 4 and the second components 6 into one container 10 and a step n) of storing components 4, 6 in a fresh or frozen state, ready to be joined as they are or after thawing, for on-demand preparation various formats of fresh filled pasta P before cooking, while avoiding exchange of water, salts and other ingredients between the first 4 and second components 6.

In a further aspect, the invention relates to a food kit 1 for on-demand preparation of fresh filled pasta P, obtained with the above discussed method.

As shown in FIG. 2, the food kit 1 comprises a container 10 containing a certain number of first components 4 consisting of substantially flat pre-formed unit portions 5 of fresh pasta and a corresponding number of second components 6 consisting of pre-dosed pralines of filling 7.

The substantially flat pre-formed unit portions of fresh pasta 5 and the pre-dosed pralines of filling 7 may be collected in a container 10 having corresponding separate compartments 10′, 10″.

In a preferred embodiment of the kit, the container may comprise the same number of unit portions and pralines to form fresh filled pasta of tortellini type with the filling contained in a sheet folded on itself, as shown in FIGS. 2 and 3.

In an alternative embodiment of the kit, not shown, the number of unit portions 5 in the container 10 may be greater than the number of pralines 7, or vice versa, to form panzerotti from a double sheet and a single filling, or ravioli from a single sheet and a double filling.

In a further aspect, the invention relates to a method of use of the food kit 1 for on-demand preparation of fresh filled pasta P, obtained with the above discussed method.

The method of use includes taking first components 4 consisting of flat unit portions of pasta 5 of a predetermined shape, and second components 6 consisting of pre-dosed pralines of filling 7 from the container 10 of the kit 1, composing by the user the first 4 and second components 6 to form fresh filled pasta P of a desired shape, while avoiding exchange of water, salts and other ingredients between the components 4, 6 under much the same conditions as preparation of homemade pasta.

In operation, after opening the layers of biocompatible material 8 containing the unit portions of pasta 5 and the packages 9 containing the pralines of filling 7, the user may place a praline 7 in a unit portion of pasta 5 and fold the latter on itself to form the filled pasta P, as schematically shown in FIG. 4.

Alternatively, the filled pasta P may be prepared by a user with a greater number of pralines 7 interposed between a pair of unit portions 5 of fresh pasta by sealing the edges 11 of the latter to form the filled pasta P, as shown in FIG. 3.

Furthermore, the high malleability of portions formed unit 5 and the total absence of pre-gelatinization of starches therein allow the user to form the filled pasta P by simply closing the edges 11 with a slight pressure and avoiding the use of additives such as starches or water.

The closed edges 11 and the cooking water will cause gelatinization of the fresh filled pasta P and ensure it will be prepared without spreads of filling.

It was experimentally found that the food kit 1 and the method of use as described above provide fresh filled pasta P that exhibits a superior silky surface, an appropriate firmness and an excellent egg flavor, like homemade pasta.

It will be apparent from the foregoing that the method of making a food kit, the food kit and the method of use of the kit of the invention achieve the intended objects and particularly avoid pre-gelatinization of the sheets of pasta before cooking.

They also prevent exchange of ingredients between the food components to thereby afford immediate preparation of fresh filled pasta before cooking, in much the same as the homemade one.

The kit of food components and the method of this invention are susceptible to a number of changes or variants, within the inventive concept disclosed in the appended claims.

All the details thereof may be replaced by other technically equivalent parts, and the materials may vary depending on different needs, without departure from the scope of the invention.

While the kit and method of the invention have been described with particular reference to the accompanying figures, the numerals referred to in the disclosure and claims are only used for the sake of a better intelligibility of the invention and shall not be intended to limit the claimed scope in any manner.

### INDUSTRIAL APPLICABILITY

The present invention may find application in industry, because it can be produced on an industrial scale in the field of food processing.

The invention claimed is:

1. A method of making a food kit for on-demand preparation of fresh filled pasta having the same properties as homemade fresh pasta, the method comprising:
making first components consisting of unit portions of single or double sheets of fresh pasta having a predetermined flat shape;
cooling, vacuum packaging, cold high-pressure pasteurizing and refrigerating said pasteurized unit portions, to maintain a structure and physical-rheological characteristics of said unit portions unaltered, while avoiding pre-gelatinization of starches, and
making second components consisting of pre-dosed pralines of filling, said second components being shaped as desired and later undergoing pasteurization and/or possibly freezing, said first components and said second components being packaged and collected in a container for fresh or frozen storage, and being ready to be joined together in their present state or after unfreezing, for on-demand preparation of formats of the fresh filled pasta before cooking, thereby avoiding exchange of water, salts and other ingredients between said first and said second components.

2. The method as claimed in claim 1, wherein said unit portions of the fresh pasta are made by pre-cutting a unit sheet into multiple portions, said unit portions being obtained by final separation along pre-cut lines.

3. The method as claimed in claim 1, wherein said unit portions, or multiple pre-cut portions, are obtained with the steps of:
a) making a dough from flour, semolina, water and eggs;
b) unidirectionally and/or multidirectionally laminating the dough to obtain a continuous sheet of predetermined thickness; and
c) cutting or pre-cutting the continuous sheet into substantially flat unit portions or multiple portions having a shape and size corresponding to the shape and size of a single piece of the fresh filled pasta.

4. The method as claimed in claim 3, wherein the step of cooling, vacuum packaging, cold high-pressure pasteurizing and refrigerating comprises:
d) rapid cooling at a first temperature which is adapted to avoid any fermentation;
e) vacuum and controlled-atmosphere packaging of the unit portions or multiple portions at a second temperature less than or equal to said first temperature;
f) applying cold High Pressure Pasteurization to the vacuum-packaged unit portions or multiple portions at a third temperature which is adapted to avoid pre-gelatinization of starch contained therein, such that a flat shape of said unit portions is not altered and the rheological and organoleptic properties of the base dough is unaffected; and
g) cooling and storing the pasteurized unit portions at a fourth temperature to obtain the first components of the food kit in a fresh or frozen state.

5. The method as claimed in claim 1, wherein said pralines are obtained with the steps of:
h) preparing a filling from ingredients according to a predetermined recipe;
i) dosing the filling into individual pralines having a weight and shape corresponding to the weight and shape of each piece of the fresh filled pasta;
j) pasteurizing the individual pralines at ambient pressure;
k) packaging the individual pralines under protective atmosphere in separate packages; and
l) cooling and refrigerating the individual pralines at a fifth temperature to obtain the second components of the food kit in a fresh or frozen state.

6. The method as claimed in claim 4, wherein said step f) of applying cold High Pressure Pasteurization to said unit portions or multiple portions is carried out at a pressure ranging from 5000 bar to 6000 bar, for a time (t) ranging from 2 min to 6 min.

7. The method as claimed in claim 3, wherein said third temperature is less than 25° C.

8. The method as claimed in claim 3, wherein the predetermined thickness of the dough ranges from 0.3 mm to 1.5 mm.

9. The method as claimed in claim 3, wherein said first temperature is less than 8-10° C., said second temperature ranging from −5° C. to 10° C.

10. A food kit for on-demand preparation of fresh filled pasta, comprising:
a given number of first components consisting of substantially flat preformed unit portions of fresh pasta; and
a corresponding number of second components consisting of pre-dosed pralines of filling obtained as claimed in claim 1.

11. The kit as claimed in claim 10, wherein said substantially flat pre-formed unit portions of fresh pasta and said pre-dosed pralines of filling are collected in a container having corresponding separate compartments.

12. A method of use of a food kit for on-demand preparation of fresh filled pasta obtained as claimed in claim 1, comprising:
taking the first components consisting of flat unit portions of pasta of a predetermined shape, and the second components consisting of pre-dosed pralines of filling from a container of the food kit; and
composing, by a user, said first and said second components to form the fresh filled pasta of a desired shape, while avoiding the exchange of water, salts and other ingredients between said first and said components under the same conditions as for preparing homemade pasta.
